(19) United States
(12) Patent Application Publication
(10) Pub. No.: US 2013/0167254 A1
(43) Pub. Date: Jun. 27, 2013

(54) Universal Serial Bus Shield

(71) Applicant: Joel Gyllenskog, Boise, ID (US)

(72) Inventor: Joel Gyllenskog, Boise, ID (US)

(21) Appl. No.: 13/335,610

(22) Filed: Dec. 22, 2011

(51) Int. Cl. G06F 21/00

(52) U.S. Cl. 726/30

(57) ABSTRACT

A system for thwarting malicious malware attacks on computing devices potentially introduced by flash drives and similar universal serial bus (“USB”) devices. The system disclosed herein includes a USB shield that treats both a hosting computer and a newly inserted USB device with appropriate caution and monitors interactions between the host and the device based on its own logic. In some embodiments, the USB shield is configured independently of its intended host or intended target device. Once configured, the shield is typically plugged into a host computer, and then a desired USB device is plugged into the shield and then monitors and blocks all communications inconsistent with its configuration parameters. In some embodiments, the USB shield modifies certain communications (such as filenames) as a safety precaution if so configured to defeat auto-run logic even if configured on a host computer.

### BACKGROUND

Modern computers, as well as many consumer devices, allow computer memory expansion by providing a universal serial bus (USB) receptacle. Hereafter, “USB” is shorthand for “universal serial bus”. The USB hardware specifications are well known in the art. USB peripheral devices usually have a plug with physical and electronic specifications dictated by well known standards. Hereafter “USB plug” refers to any such a plug. Likewise, devices capable of receiving a USB plug have a receptacle with physical and electronic specifications dictated by well known standards, Hereafter “USB receptacle” refers to any such receptacle.

USB devices can be almost any computer peripheral. Examples of well known USB peripherals are file storage devices (flash drives), computer mice, computer keyboards, bar-code scanners, and computer printers.

Since USB file storage devices are small, inexpensive, and highly portable, USB file storage devices are ubiquitous in modern computing devices. The portable nature of USB file storage devices results in a single USB file storage device often being plugged into a number of different hosting devices. For example, a consumer can store his or her personal music collection on a USB file storage device and then play that music on a computer, a smart phone, or an automobile stereo system.

The highly portability characteristic of USB file storage devices make them a popular target as of computer viruses. Most computer systems, including Microsoft Window, Unix and its variants including Linux, and the Apple operating system, are designed to interact with a new USB device in real time when it is plugged into the system. Most of the USB protocols begin with a handshaking process wherein the newly plugged in device identifies itself and the hosting computer then loads appropriate drivers from a well known library. Most protocols also allow code on the USB device to be automatically executed to provide for specialized initialization of the device or perhaps to perform a desirable function on the host computer. In the case of USB file storage devices, and Microsoft Windows based computers, the appearance of files with special predefined names will be interpreted as friendly programs and will be automatically executed on the host computer. Virus programs often exploit the auto-run feature by providing files properly named to invoke the auto-run logic and then load infected malware on a target computer. For all purposes herein, the terms “computer” and host computer” are intended to include any and all electronic devices capable of executing computer code (and thus capable of executing malicious malware).

The auto execution functionality is a well known security hole that is frequently exploited, and a number of prior art solutions are available to thwart damage from computer viruses. The most well known is standard anti-virus software installed in the host computer. Since a USB file storage device is treated like a native memory device once installed, anti-virus software running on a host computer can examine files on the USB file storage and identify and hopefully quarantine or remove viruses as they are discovered.

The computer hosted anti-virus solution has several drawbacks. The first is the anti-virus software needs to be installed and aware of the particular virus before the malicious device is plugged in. Many computers have either no anti-virus software or inadequate versions installed and thus fail to protect. One solution to address this problem is to put the anti-virus software on the USB file storage and then have it automatically installed and execute when the device is plugged in. This solution may work well for “thin client” scenarios, where the bulk of a computing environment is stored on a USB file storage as is often the case at university and other library-centric computing environment. In these scenarios, the computers themselves are fairly bland and empty hardware platforms and only “come alive” when mated with a USB file storage having all or part of the required operating system, application suite, and data associated with a particular user.

Unfortunately, these kinds of prior art security systems make assumptions that cannot be guaranteed and thus fail whenever the requisite assumptions are not met. In the case of anti-virus software executed on a host computer, there is an assumption that the host computer has been inoculated from computer virus and the protection is aimed toward blocking infections coming from the USB drive. In the case of anti-virus on the USB file storage, the assumption is made that the device is inoculated and the system protects the device from unwanted infection from the host computer.

However, in many situations, the assumption that the host computer is inoculated or the USB device is inoculated are not in reality met and then the anti-virus logic fails and computer viruses are spread. What is needed is a virus protection solution that does not rely on inoculation status of either a USB device or the hosting device in order to protect both the USB device and the host computer simultaneously.

### BRIEF SUMMARY OF THE INVENTION

The present invention addresses the shortcoming of the prior art by including both the anti-virus logic and the hardware processing component on a dedicated and isolated hardware platform herein called a USB shield that treats both the hosting computer and the newly inserted USB device with appropriate caution and monitors every interaction between the host and the device based on its own logic. The USB shield is configured independently of its intended host or intended target device. Once configured, the shield is typically plugged into a host computer, and then a desired USB device is plugged into the shield. The shield monitors and blocks all communications inconsistent with its configuration parameters and furthermore modifies certain communications (such as filenames) as a safety precaution if so configured to defeat auto-run logic even if configured on a host computer.

### BRIEF DESCRIPTION OF THE DRAWINGS

FIG. 1 is a block diagram illustrating prior art usage of a USB file storage with a computer.

FIG. 2 is a block diagram illustrating generally the present inventions as it relates to USB file storage devices.

FIG. 3 is a block diagram illustrating generally the present invention.

FIG. 4 is a block diagram illustrating the present invention as it relates to generic USB plug-in devices.

### DETAIL DESCRIPTION OF THE PREFERRED EMBODIMENT

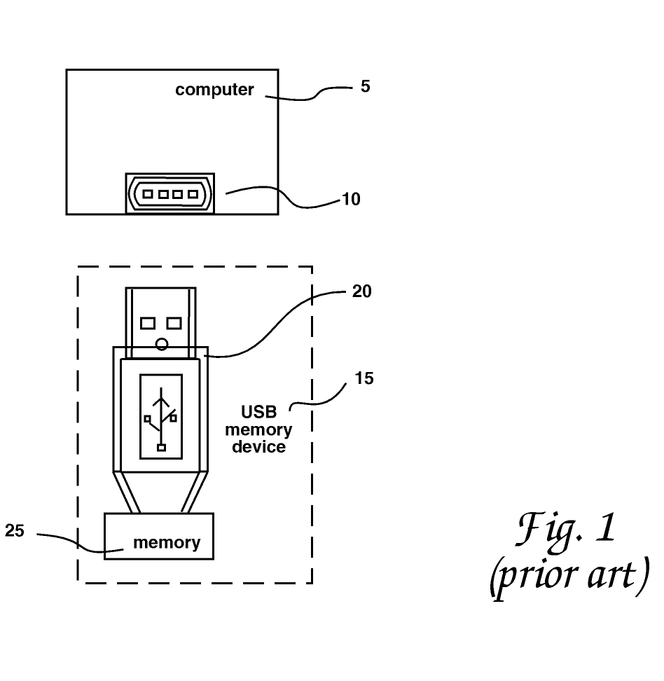

FIG. 1 shows generally the prior art as it relates to the present invention. Referring to FIG. 1, the prior art environment of primary interest includes a computer 5, the computer having one or more USB receptacles 10 wherein various USB peripherals can be physically plugged into the computer 5. FIG. 1 illustrates a generic USB file storage 15 having electronic memory 25, typically implement as flash memory. USB file storage 15 includes a USB plug physically and mechanically compatible with the USB receptacle 10 wherein the USB plug 20 can be plugged into the USB receptacle 10 to achieve physical connectivity. Using this prior art arrangement, the computer 5's memory is expanded to include the memory 25 when the USB file storage 15 is plugged into the computer 5 using the USB plug 20 and the USB receptacle 10.

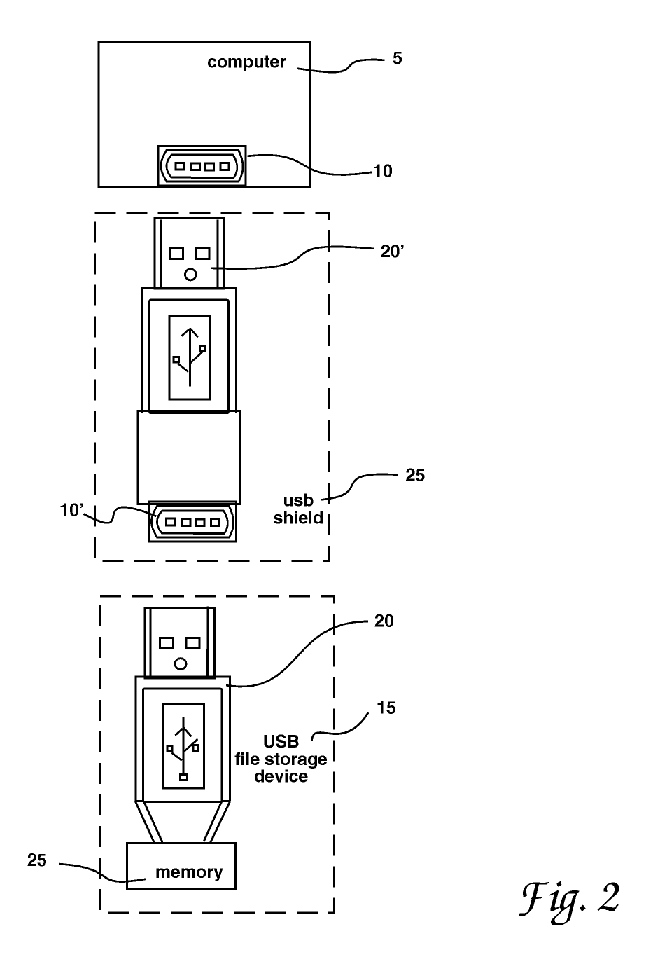

FIG. 2 shows generally how the present invention is physically introduced into the prior art environment of FIG. 1. Referring 2 FIG. 2, the new USB shield 25 is introduced physically between the USB file storage 15 and the computer 5. The USB shield has a USB plug 20′ compatible with the computer 5's USB receptacle 10 and a USB receptacle 10′ compatible with the USB file storage 15's USB plug 20. When the invention is deployed, the USB shield 25 is plugged into the computer 5 by plugging USB plug 20′ of the USB shield 25 into the USB receptacle 10 of the computer 5. The USB file storage device 15 is then plugged into the USB shield 25. Specifically, the USB plug 20 of the USB file storage device 15 is plugged into the USB receptacle 10′ of the USB shield 25.

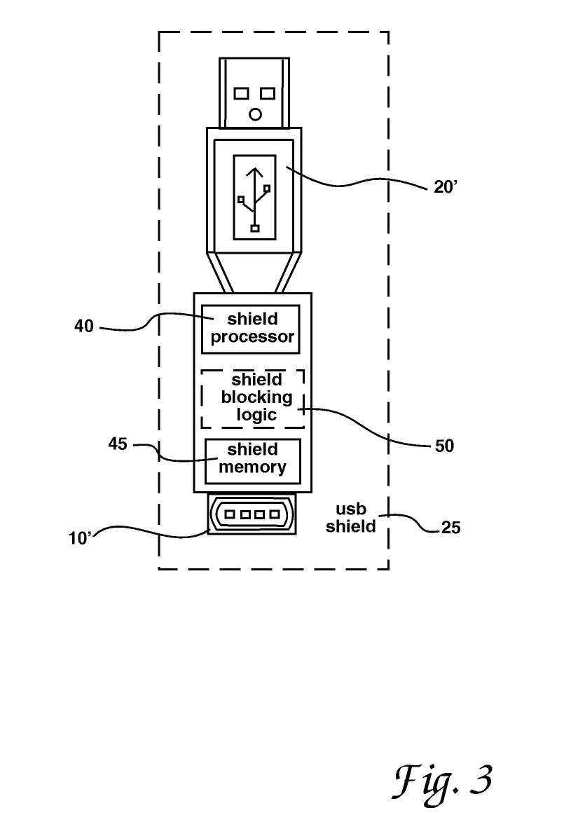

FIG. 3 show generally the major components of the USB shield 25. Referring to FIG. 3, the USB shield 25 further includes a computer processor herein referred to as the shield processor 40. The USB shield 25 further includes its own computer memory herein referred to as shield memory 45. The USB shield 25 further includes shield blocking logic 50. The shield processor 40 and the shield memory 45 are hardware in the preferred embodiment and the shield blocking logic 50 is implemented as software/firmware installed completely within the USB shield 25. The shield blocking logic 50 includes drivers to interface with the USB receptacle 10′ and the USB plug 20. The shield blocking logic receives all communications from the computer 5 directed toward the USB media decide 15 and decides whether to pass the communication on to the USB file storage 1, or to block the communication, or to modify the communications, depending on how the USB shield 25 is configured. Likewise, all communication from the USB file storage 15 is received by the shield block logic 50 and the USB shield 25 all decides analogously whether to pass on such communications to the computer 5 unaltered, OR whether to block a particular attempted communication, OR whether to alter such a communication.

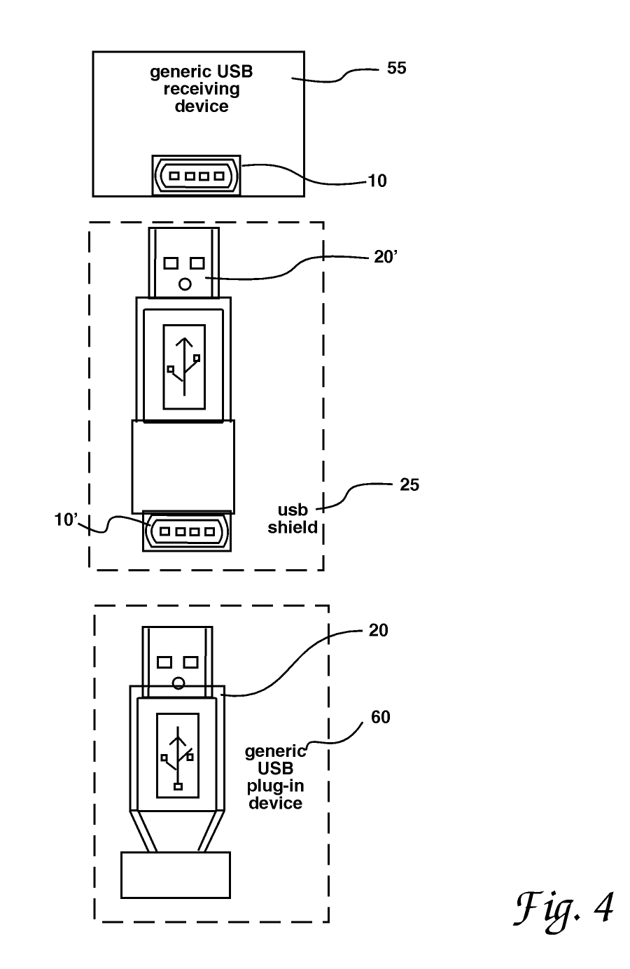

FIG. 4 generally illustrates the present invention as it relates to generic prior art USB file storage devices. Referring 2 FIG. 4, the USB shield 25 is introduced physically between the generic USB plug-in device 60 and the generic USB receiving device 55. The USB shield 25 has a USB plug 20′ compatible with the generic USB plug-in device 60's USB receptacle 10 and the USB shield 25 further includes a USB receptacle 10′ compatible with the generic USB plug-in device 60's USB plug 20. When the invention is deployed, the USB shield 25 is plugged into the computer 5 by plugging USB plug 20′ of the USB shield 25 into the USB generic USB receiving device 55 using USB receptacle 10. The generic USB plug-in device 60 is then plugged into the USB shield 25. Specifically, the USB plug 20 of the generic USB plug-in device 60 is plugged into the USB receptacle 10′ of the USB shield 25.

How the shield blocking logic functions in a given scenario depends on how it is configured at the time the attempted communication takes place. For trouble shooting purposes, the USB shield 25 can be configured in a pass through-mode where all communications in both directions are passed through unaltered as they are received. In this mode, the USB shield 25 is logically invisible, and, except perhaps for minor electrical lags caused by the additional hardware, the USB file storage and the computer 5 should behave exactly as they would if configured without the USB shield 25 was not present as per the illustration of FIG. 1.

A complementary mode is block mode where all communications each way are completely blocked. The blocking configuration thus treats the USB file storage 15 as if it was physically unplugged from the computer 5.

### Operation

The USB shields must be configured prior to use. In the preferred embodiment, the configuration is set at the factory and cannot be altered by the end user and is set to only accept and allow communication between simple USB file storage devices and auto-running of files from the driver is disallowed. In other embodiments, the device can be configured by plugging it into a computer having configuration software installed and user authentication such as an authorized name and password must be provided to alter or view the configuration.

Once the shield is configured, it is deployed by plugging the shield into a receptacle typically on a host computer and then a USB device is plugged into the shield. The shield intercepts and inspects the initially handshaking data exchanges to ensure the device is identifying itself as required by the USB shield configuration. For example, if the USB shield is configured only for file storage device, a USB device identifying itself as a printer would then immediately blocked and disabled and no communication between the suspicious USB device and the host computer will be allowed. Likewise, if so configured, the USB shield will prevent the appearance of any file names that would be auto run by either hiding the files or renaming them, thus disallowing all auto-run files when so configured. Likewise; all USB communication between the USB device and the hosting device is monitored and any communication deemed inconsistent with the USB shield configuration parameters will be blocked and the device with effectively be disabled, allowing no more interactions with the host computer. Alternatively, the USB shield could be configured to present a notification through any one of a number of well known notification schemes when suspicious activity is detected.

In one embodiment, the auto run logic of the USB shield, specific to Microsoft Windows based computers, works as follow. When the USB shield and the USB flash drive first are physically engaged, the USB shield will query the USB flash drive and determine the names of files in the root directory. It will compare those names with a list it maintains. This list might contain entries of the patterns “*.lnk” or “autorun.inf”. If a filename matching either pattern is found, the files on the USB flash drive will be modified by the USB shield and the files so identified will be renamed to names of the forms “*_lnk” or “autorun_inf” respectively. This will effectively disable the auto run fixture of the Microsoft Windows based computer and allow all subsequent movement of data between the USB flash drive and the computer to be done without requiring the USB shield to inspect and potentially modify data in the packets.

The descriptions of these embodiments have been provided for the purposes of illustration, not limitation. One skilled in the art can apply the principles of the invention to a number of devices and hosting platforms not specifically described herein in the spirit of the invention. For these and other reasons, the invention is only limited by the claims as set forth below.

We claim:

1. A system for protecting a host computer from a computer virus potentially introduced from a computer peripheral device in a computing environment comprising:
a shielding device for shielding said host computer from said computer peripheral device, wherein said shielding device is capable of providing a first hardware interface from said computer peripheral device and is capable of providing a second hardware interface to said host computer,
wherein shielding device further includes a filter wherein data being transmitted by said computer peripheral device destined for said host computer can be prevented from being transferred to said host computer.

2. The system of claim 1, wherein said first hardware interface is a USB plug and said second hardware interface is a USB receptacle.

3. The system of claim 2, wherein said filter only permits data consistent with the computer peripheral device being a data storage device to be passed through to said host computer.

4. The system of claim 3, wherein said filter prohibits any file present on said computer peripheral device from being automatically executed when said computer peripheral device is connected to said host computer.

5. The system of claim 2, wherein said filter prohibits any file present on said computer peripheral device from being automatically executed when said computer peripheral device is connected to said host computer.

6. The system of claim 1, wherein said filter only permits data consistent with the computer peripheral device being a data storage device to be passed through to said host computer.

7. The system of claim 6, wherein said filter prohibits any file present on said computer peripheral device from being automatically executed when said computer peripheral device is connected to say host computer.

8. The system of claim 1, wherein said filter prohibits any file present on said computer peripheral device from being automatically executed when said computer peripheral device is connected to said host computer.

9. A system for protecting a host computer from a computer virus potentially introduced from a computer peripheral device in a computing environment comprising:
a shielding device for shielding said host computer from said computer peripheral device,
wherein said shielding device is capable of providing a first hardware interface from said computer peripheral device and is capable of providing a second hardware interface to said host computer,
wherein shielding device further includes a filter wherein data being transmitted by said computer peripheral device destined for said host computer can be prevented from being transferred to said host computer.
wherein said filter prohibits any file present on said computer peripheral device from being automatically executed when said computer peripheral device is connected to said host computer by renaming any potentially automatically executable file.

10. The system of claim 9, wherein said first hardware interface is a USB plug and said second hardware interface is a USB receptacle.

11. The system of claim 10, wherein said filter blocks data falsely identifying said computer peripheral device from reaching said host computer.

12. The system of claim 9, wherein said filter blocks data falsely identifying said computer peripheral device from reaching said host computer.

13. A system for protecting a host computer from a computer virus potentially introduced from a computer peripheral device in a computing environment comprising:
a shielding device for shielding said host computer from said computer peripheral device,
wherein said shielding device is capable of providing a first hardware interface from said computer peripheral device and is capable of providing a second hardware interface to said host computer,
wherein shielding device further includes a filter wherein data being transmitted by said computer peripheral device destined for said host computer can be prevented from being transferred to said host computer.
wherein said filter blocks data falsely identifying said computer peripheral device from reaching said host computer.

14. The system of claim 13, wherein said first hardware interface is a USB plug and said second hardware interface is a USB receptacle.

15. The system of claim 14, wherein said filter only permits data consistent with the computer peripheral device being a data storage device to be passed through to said host computer.

16. The system of claim 15, wherein said filter prohibits any file present on said computer peripheral device from being automatically executed when said computer peripheral device is connected to said host computer.

17. The system of claim 14, wherein said filter prohibits any file present on said computer peripheral device from being automatically executed when said computer peripheral device is connected to said host computer.

18. The system of claim 13, wherein said filter only permits data consistent with the computer peripheral device being a data storage device to be passed through to said host computer.

19. The system of claim 18, wherein said filter prohibits any file present on said computer peripheral device from being automatically executed when said computer peripheral device is connected to said host computer.

20. The system of claim 13, wherein said filter prohibits any file present on said computer peripheral device from being automatically executed when said computer peripheral device is connected to said host computer.
